(19) United States
(12) Patent Application Publication
(10) Pub. No.: US 2008/0185813 A1
(43) Pub. Date: Aug. 7, 2008

(54) Portable well flare equipment trailer

(76) Inventor: Douglas H. Watson, Brooks (CA)

Correspondence Address: Redmond F. Gallagher, 7420 Milner Dr., #1000, Colorado Springs, CO, 80920, US

(21) Appl. No.: 11/702,292

(22) Filed: Feb. 6, 2007

(51) Int. Cl. B62D 53/08; B65D 88/12; E21B 41/00

(52) U.S. Cl. 280/404; 166/244.1; 220/562

(57) ABSTRACT

An equipment trailer for initially servicing a petroleum well at a remote site comprising: a solids and fluid collection tank mounted centrally on the trailer; a front and rear flare column support for supporting a gas flare stack having a base an intermediate column and a head; and, a pipe rack positioned along a lateral side of the trailer to removably carry lengths of pipeline therein, said lengths of pipeline used to interconnect the well to the collection tank and thereafter to connect an upper portion of the collection tank to a base of the flare stack. Then in a single trip an operator may haul all of the equipment necessary to initially service the well at the remote site, then after the equipment is then set up, interconnected to the well and used, an operator may return to the remote site to disassemble, reload, and again remove all of the equipment back to a storage/tank cleaning location in a single trip.

### FIELD OF THE INVENTION

This invention relates to flaring surplus gas from petroleum wells. More particularly this invention relates to a portable apparatus and method for temporarily flaring surplus gas erupting from wells prior to initial production.

### BACKGROUND OF THE INVENTION

After a gas well has been completed and fractured, initial gas flow is frequently filled with fluids and the fracturing gas, usually nitrogen or carbon dioxide. For two to five days the gas must be tested and flared. Until the gas becomes 70% burnable it must be wasted. For environmental reasons the solids and fluids are captured in a tank for disposal, and the gases containing petrocarbons are flared. After the well achieves producing status it is shut then shut in until it can be connected to a pipeline.

Petroleum companies handling the completion typically hire contractors to transport tanks, pipelines, and flare stacks to the well sites. After two to five days when the gas becomes 70% burnable the tanks pipelines, and flare stacks must be hauled off the well site. The same contractors may be hired to manage the initial well flaring and fluid collection. The inventor herein has owns and operates equipment to temporarily flare and collect fluids from new wells. The industry typically has hauled the flare stack and pipelines to the well sites and then separately transported fluid collection tanks to the wells sites. After two to five days the equipment then is hauled off the well site to a storage/collection tank cleaning location. Again, typically at least two trips must be made from the remote location, one trip to remove the storage tank and another to remove the flare stack. The inventor herein has determined a more cost effective and efficient method to perform his service using a trailer he has developed.

### OBJECTS OF THE INVENTION

It is an object of this invention to disclose a trailer with which a newly flowing well can more efficiently be serviced. It is an object of this invention to disclose a trailer which can concurrently haul pipe, a flare stack, and a fluid collections tank to a well site. All of the equipment needed to initially flare the well can be hauled to the remote well site in a single trip. Similarly after the service is completed all of the equipment can be reloaded onto the trailer and removed to a storage/collection tank cleaning location in a single trip. It is yet a final object of this invention to disclose a more efficient method to bring a well to producing status.

One aspect of this invention provides for an equipment trailer for initially servicing a petroleum well at a remote site comprising: a solids and fluid collection tank mounted centrally on the trailer; a front and rear flare column support for supporting a gas flare stack having a base an intermediate column and a head; and, a pipe rack positioned along a lateral side of the trailer to removably carry lengths of pipeline therein, said lengths of pipeline used to interconnect the well to the collection tank and thereafter to connect an upper portion of the collection tank to a base of the flare stack. Then in a single trip an operator may haul all of the equipment necessary to initially service the well at the remote site, then after the equipment is then set up, interconnected to the well and used, an operator may return to the remote site to disassemble, reload, and again remove all of the equipment back to a storage/tank cleaning location in a single trip.

In a preferred aspect of this invention the collection tank is mounted and configured so that it may be used at the well site on the trailer, and the column supports each comprise a pair of opposite legs, each leg having a lower end portion connected to an opposite lateral side portion of the trailer, and each leg having an upper portion attached to the other opposite leg, and said upper portions of the upper legs together carry a column reception portion.

Various other objects, advantages and features of this invention will become apparent to those skilled in the art from the following description in conjunction with the accompanying drawings.

### FIGURES OF THE INVENTION

FIG. 1 is a perspective view of an equipment trailer configured with a collection tank, pipelines and a flare stack.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

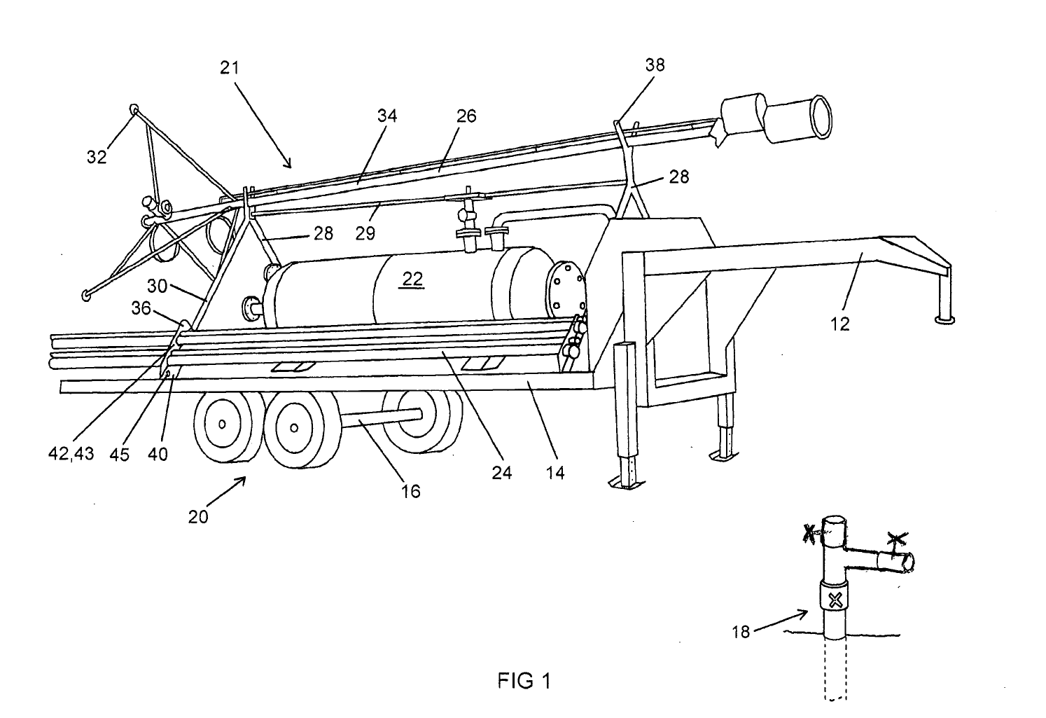

Turning now to the drawings and more particularly to FIG. 1 we have a perspective view of an equipment trailer 20 configured with a collection tank 22, pipelines 24 and a flare stack 26. Most generally an equipment trailer 20 for initially servicing a petroleum well 18 at a remote site comprises: a solids and fluid collection tank 22 mounted centrally on the trailer 20; a front and rear flare column support 28 for supporting a gas flare stack 26 having a base 32 and an intermediate column 34; and, a pipe rack 36 positioned along a lateral side of the trailer 20 to removably carry lengths of pipeline 24 therein. Said lengths of pipeline 24 are used to interconnect the well 18 to the collection tank 22 and base 32 of the flare stack 26. Then in a single trip an operator may haul all of the equipment 21 necessary to initially service the well 18 at the remote site, then after the equipment 21 is then set up, interconnected to the well 18 and used, an operator may return to the remote site to disassemble, reload, and again remove all of the equipment 21 back to a storage/tank cleaning location in a single trip.

Most preferably the collection tank 22 is mounted and configured so that it may be used at the well site on the trailer 20, and the column supports 28 each comprise a pair of opposite legs 30, each leg 30 having a lower end portion connected to an opposite lateral side portion of the trailer 20, and each leg 30 having an upper portion attached to the other opposite leg 30, and said upper portions of the upper legs 30 together carry a column reception portion 38. Most preferably an upper portion of the column supports 28 are positioned behind and in front of the collection tank 22 on the trailer 20 so that the tank 22 may be conveniently lifted from the trailer 20 for cleaning. A top portion of the column supports 28 are interconnected with a removeable member 29, and wherein a top portion of the front column support is additionally interconnected to a front portion of the trailer, said interconnections made for stability.

Most preferably the rear column support 28 is spaced forward from a rear portion of the trailer 20 to provide space above a rear portion of the trailer 20 to accommodate the base 32 of the flare stack 26. In the most preferred embodiment of the invention there are similar pipe racks 36 each extending along opposite lateral sides of the trailer 20, Each of the pipe racks 36 comprise a lower notched portion 40 to receive lengths of pipeline 25 and an upper arm 42 which when secured maintains lengths of pipeline 25 in the lower notched portion 40.

In a preferred embodiment of the invention the upper portion 42 of the pipe rack 36 comprises an upper swinging arm 43 which is maintained in position with a hitch pin 45. In the most preferred embodiment of the invention each lateral side rack 36 is configured to carry 4 lengths of pipeline 24, 2-2 inch which extend from the well 18 to the tank 22 and 2-3 inch which can be used to extend from the tank 22 to the base of the flare stack 26.

In the most preferred embodiment of the invention the pipe racks 36 are carried by a lower portion of the opposite legs 30. Most preferably the equipment trailer 20 is of the type comprising two axles 16, a steel frame 14 and a gooseneck 12, so that it can be pulled with a pick-up truck (not shown).

A general method of initially servicing a petroleum well 18 comprises the following steps: providing an equipment trailer 20 having a solids and fluid collection tank 22 mounted centrally on the trailer 20; providing a front and rear flare column support 28 to carry a flare stack 26; and providing a pipe rack 36 positioned along a lateral side of the trailer 20 to removably carry lengths of pipeline 24 therein, said lengths of pipeline 24 used to interconnect the well 18 to the collection tank 22 and thereafter to connect an upper portion of, the collection tank 22 to a base of the flare stack 26. Then in a single trip an operator may haul all of the equipment 21 necessary to initially service the well 18 at the remote site, then after the equipment 21 is then set up, interconnected to the well 18 and used, an operator may return to the remote site to disassemble, reload, and again remove all of the equipment back 21 to a storage/tank cleaning location in a single trip.

The above general method can limited by more the equipment trailer 20 specifications described above.

While the invention has been described with preferred specific embodiments thereof, it will be understood that this description is intended to illustrate and not to limit the scope of the invention, which is defined by the following claims.

I claim:

1) An equipment trailer for initially servicing a petroleum well at a remote site comprising:
a solids and fluid collection tank mounted centrally on the trailer;
a front and rear flare column support for supporting a gas flare stack having a base and an intermediate column; and,
a pipe rack positioned along a lateral side of the trailer to removably carry lengths of pipeline therein, said lengths of pipeline used to interconnect the well to the collection tank and thereafter to connect an upper portion of the collection tank to a base of the flare stack;
so that in a single trip an operator may haul all of the equipment necessary to initially service the well at the remote site, then after the equipment is then set up, interconnected to the well and used, an operator may return to the remote site to disassemble, reload, and again remove all of the equipment back to a storage/tank cleaning location in a single trip.

2) An equipment trailer as in claim 1 wherein the collection tank is mounted and configured so that it may be used at the well site on the trailer, and wherein the column supports each comprise a pair of opposite legs, each leg having a lower end portion connected to an opposite lateral side portion of the trailer, and each leg having an upper portion attached to the other opposite leg, and wherein said upper portions of the upper legs together carry a column reception portion.

3) An equipment trailer as in claim 2 wherein an upper portion of the column supports are positioned behind and in front of the collection tank on the trailer so that the tank may be conveniently lifted from the trailer for cleaning; and wherein a top portion of the column supports are interconnected with a removeable member, and wherein a top portion of the front column support is additionally interconnected to a front portion of the trailer, said interconnections made for stability.

4) An equipment trailer as in claim 3 wherein the rear column support is spaced forward from a rear portion of the trailer to provide space above a rear portion of the trailer to accommodate the base of the flare stack.

5) An equipment trailer as in claim 2 wherein there are similar pipe racks each extending along opposite lateral sides of the trailer and wherein each of the pipe racks comprise a lower notched portion to receive lengths of pipeline and an upper arm which when secured maintains the lengths of pipeline in the lower notched portion of the pipe rack.

6) An equipment trailer as in claim 5 wherein each lateral side rack is configured to carry four lengths of pipeline, 2-2 inch which extend from the well head to the vessel and 2-3 inch lengths of pipeline which can be used to extend from the tank to the base of the flare stack.

7) An equipment trailer as in claim 6 wherein the upper portion of the pipe rack comprises an upper swinging arm which is maintained in position with a hitch pin.

8) An equipment trailer as in claim 7 wherein the lower portion of the pipe racks are carried by a lower portion of the opposite legs.

9) An equipment trailer as in claim 1 which comprises two axles, a steel frame and a gooseneck, so that it can be pulled with a pick-up truck.

10) A method of initially servicing a petroleum well comprising the following steps:
providing an equipment trailer having a solids and fluid collection tank mounted centrally on the trailer;
providing a front and rear flare column support to carry a flare stack; and
providing a pipe rack positioned along a lateral side of the trailer to removably carry lengths of pipeline therein, said lengths of pipeline used to interconnect the well to the collection tank and thereafter to connect an upper portion of the collection tank to a base of the flare stack;
so that in a single trip an operator may haul all of the equipment necessary to initially service the well at the remote site, then after the equipment is then set up, interconnected to the well and used, an operator may return to the remote site to disassemble, reload, and again remove all of the equipment back to a storage/tank cleaning location in a single trip.

11) A method as in claim 10 wherein the collection tank is mounted and configured so that it may be used at the well site on the trailer, and wherein the column supports each comprise a pair of opposite legs, each leg having a lower end portion connected to an opposite lateral side portion of the trailer, and each leg having an upper portion attached to the other opposite leg, and wherein said upper portions of the upper legs together carry a column reception portion.

12) A method as in claim 11 wherein an upper portion of the column supports are positioned behind and in front of the collection tank on the trailer so that the tank may be conveniently lifted from the trailer for cleaning; and wherein a top portion of the column supports are interconnected with a removeable member, and wherein a top portion of the front column support is additionally interconnected to a front portion of the trailer, said interconnections made for stability.

13) A method as in claim 12 wherein the rear column support is spaced forward from a rear portion of the trailer to provide space above a rear portion of the trailer to accommodate a base of the flare stack.

14) A method as in claim 11 wherein there are similar pipe racks each extending along opposite lateral sides of the trailer and wherein each of the pipe racks comprise a lower notched portion to receive pipes and an upper arm which when secured maintains pipes in the lower notched portion of the pipe rack.

15) A method as in claim 14 wherein each lateral side rack is configured to carry four lengths of pipeline, 2-2 inch which extend from the well head to the vessel and 2-3 inch lengths of pipeline which can be used to extend from the tank to the base of the flare stack.

16) A method as in claim 15 wherein the upper portion of the pipe rack comprises an upper swinging arm which is maintained in position with a hitch pin.

17) A method as in claim 16 wherein the lower portion of the pipe racks are carried by a lower portion of the opposite legs.

18) A method as in claim 10 which comprises two axles, a steel frame and a gooseneck, so that it can be pulled with a pick-up truck.
